(19) United States
(12) Patent Application Publication
(10) Pub. No.: US 2006/0144826 A1
(43) Pub. Date: Jul. 6, 2006

(54) Process for laser welding coated plates

(76) Inventors: Wolfgang Becker, Ulm (DE); Markus Beck, Oberelchingen (DE); Klaus Goth, Sindelfingen (DE); Mike Paelmer, weil der Stadt (DE); Claus-Dieter Reiniger, Remshalden (DE); Daniel Zauner, Ballendorf (DE)

Correspondence Address: AKERMAN SENTERFITT, P.O. BOX 3188, WEST PALM BEACH, FL, 33402-3188, US

(21) Appl. No.: 10/790,388

(22) Filed: Mar. 1, 2004

(30) Foreign Application Priority Data
Feb. 28, 2003 (DE) 103 09 157.2-34

(51) Int. Cl. B23K 26/20

(52) U.S. Cl. 219/121.64

(57) ABSTRACT

With many coated plates, in particular zinc (galvanized) and organic coated sheet metal as are employed in the automobile industry, the coating material has a significantly lower boiling point than the melting point of the sheet metal material. Therefore in the case of laser welding of this type of sheet metal with zero gap in the overlap abutment area to a explosion like vaporization of coating material, which take along or entrain molten sheet metal material and strongly damage the quality of the joint. For improving the connection it has already been proposed that no gap be provided between the sheets, but rather these are positioned directly over each other and then first by means of first laser beam to warm until vaporization of the coating and subsequently to weld the uncoated sheets by means of a second laser beam. The disadvantage therein is above all the elaborate apparatus set up or complexity for the two required optical systems. The task of the present invention is thus comprised therein, to reduce the apparatus complexity and at the same time to at least maintain the work quality, preferably to improve it. The task is solved by a process in which by means of a signal laser beam first all plates can be uncoated and thereafter the plates are welded along the uncoated area with the same laser beam.

### BACKGROUND OF THE INVENTION

1. Field of Invention

The invention concerns a process for laser welding coated plates according to the precharacterizing portion of Patent Claim 1. A process of this type is already known from JP-04231190 A.

2. Related Art of the Invention

With many coated plates, in particular zinc treated (galvanized) and organic coated sheet metal as are employed in the automobile industry, the boiling point of the coating material is significantly lower than the melting point of the sheet metal material. Thus, in the case of laser welding this type of sheet metal with no gap in the overlap area between two sheets, an explosion-like vaporization of coating material occurs, taking along molten sheet metal material and strongly degrading the quality of the joint.

For improvement of the connection quality it has already been proposed to use spacers to produce narrow gaps between the sheets such that the vaporized coating material can escape. Suitable crater shaped spacers can be produced by laser strafing the upper surface (irradiating the sheet metal with pulsed laser to form roughness) according to JP 11-047967.

A disadvantage therein is on the one hand the required relatively long preparation and processing time, which can substantially increase the costs in particular in the case of series production.

On the other hand, a part of the molten sheet material always flows between the sheets, including in the interstices (gap), during production of the welding joint, as a result of which some material volume is then missing in the area of the welding seam outer surface, and this causes outer surface defects in the form of seam pockets.

Thus, it has already been proposed in accordance with JP-04231190 A to provide no gap between the sheets, but rather to position these over each other, then first to warm by means of a first laser beam until evaporation of the coating, and subsequently to weld the uncoated sheets by means of a second laser beam. Both laser beams and their associated optical devices are guided by means of a robot. A disadvantage therein is primarily the complexity and expense for the equipment of the two required optical systems.

### SUMMARY OF THE INVENTION

The task of the present invention is thus comprised of reducing the necessary apparatus complexity and at the same time at least maintain the processing quality, if not to improve it.

With regard to the process to be provided, the invention is set forth in accordance with the characteristics of Patent Claim 1. The remaining claims represent advantageous embodiments and further developments of the inventive process (Patent Claims 2-5).

With regard to the process to be provided, the task of the invention is inventively solved thereby, that two coated plates are positioned one on top of the other, as gap free as possible, then during a first process step first the side of the plate facing the laser beam is warmed with the laser beam in such a manner that the coating of both plates on the sides facing each other evaporates and that no plate melts, and that thereafter during a second process step the two plates are welded over the uncoated area, wherein both process steps are carried by the same laser beam with essentially the same power and focusing, however varying rates of travel. During the first process step the laser beam is moved with such speed that the plate facing it is sufficiently warmed to allow the coating between the two plates to evaporate; however, the plates themselves do not melt or do not completely melt through. The evaporated coating redistributes itself between the plates positioned without a gap and condenses in cooler areas, not, however, in the hot working zone. During the second process step the laser beam moves over the uncoated work line again but at a slower speed. On the basis of the lower speed of advance the two plates are melted along the working line and welded to each other along the uncoated area.

The essential advantage of the present inventive device, in comparison to JP-04231190 A, is comprised therein that only one laser beam, and therewith also only one optical device, is needed for laser beam guidance, whereby the expense of the apparatus is cut in half.

In a preferred embodiment of the inventive process the laser beam is guided on the surface using a scanner device. A scanner device is a particularly rapid and flexible beam deflecting device, for example a mirror system (comprising at least one single- or multi-axial controllable pivotable mirror) or even an acoustic-optical modulator.

The greatest advantage of this inventive process, in comparison to that proposed in JP-04231190 A, is comprised in that the scanner device is moved evenly relative to the surface of a plate, wherein the scanner device guides the laser beam for a brief work time over a work line for evaporating the coating, and then very rapidly again returns the laser beam to its beginning point, in order renewed to travel over the work line, however this time slower, and thus to carry out the welding process. For this, the apparatus set-up for the optical guidance of a second laser beam, as well as the time needed for the repositioning of the laser beam, can be dispensed with, during which time a robot guided laser beam conventionally must be switched off. Thereby in the present invention a very high degree of utilization of the laser system is made possible. In contrast thereto in conventional systems, such as employed for example in JP-04231190 A, laser beams are guided by means of a rigid lens system over the lines being worked. In order to start a new welding seam, the laser beam must be guided to the beginning and for this the lens system must be moved relative to the construction component. During this time the laser must be switched off in order to avoid untended damage to the component part. As a consequence, the embodiment according to the present invention requires only a fraction of the processing time in comparison to that of JP-04231190 A.

In a further preferred embodiment of the inventive process the laser beam is focused in such a manner that its focus is between 0 and 50 mm, preferably between 5 and 30 mm, in particular approximately 20 mm, above the surface of the side of the plate facing the laser beam. Thereby it is achieved that the area on the surface illuminated by the laser (footprint) exceeds the illuminated surface area in the case that the laser is focused on the surface by preferably at least 50%, better yet 200%.

Alternatively, or additionally thereto, a further widening of the work surface can be accomplished by movement of the illumination surface by means of minimal deflection of the laser beam (superimposing a transverse movement component on top of the main direction of advancement; so-called beam spinning). Beam spinning can be used in both, or also only the one, preferably the second, process step.

A two dimensional warming of this type evenly distributes the evaporation of the coating and the melting of the sheet and favors the development of an even weld seam.

In a further preferred embodiment of the inventive process the first and second process steps occur alternating, in the manner of a step seam. That is, first a short processing line of 3 to 20 mm length, preferably 5 mm, is past over one of more times with a high rate of advance of the laser beam, whereby this segment is uncoated. Thereafter the laser beam is returned to the beginning of the work line and travels this renewed with reduced speed of advancement, thereby causing welding. Thereafter the process is repeated in a smaller separation (3 to 20 mm) in the direction of advancement, is repeated, and thereafter again repositioned and repeated, so that by and by a dashed weld seam is formed in the manner of a step seam.

Alternatively, first two short strips could be uncoated and only thereafter do the welding and de-coating proceed alternatingly, so that the weld step does not occur respectively directly following the decoating step, but rather always two steps back. Thereby more time is given for the coating vapor to distribute itself between the plates and therewith to reduce its vapor pressure. Nevertheless, the time between the first and second process steps is so small, that the uncoated plate only slightly cools and therewith the laser beam need only be guided slightly slower during the second process step in order to introduce sufficient energy for melting and welding the plates. In this manner the otherwise conventional explosion-like evaporation is almost completely precluded.

### BRIEF DESCRIPTION OF THE DRAWING

In the following, on the basis of FIG. 1, the inventive process will be described in greater detail using two illustrative embodiments:

Therein there is shown

FIG. 1 laser beam guidance for alternatingly de-coating and welding.

### DETAILED DESCRIPTION OF THE INVENTION

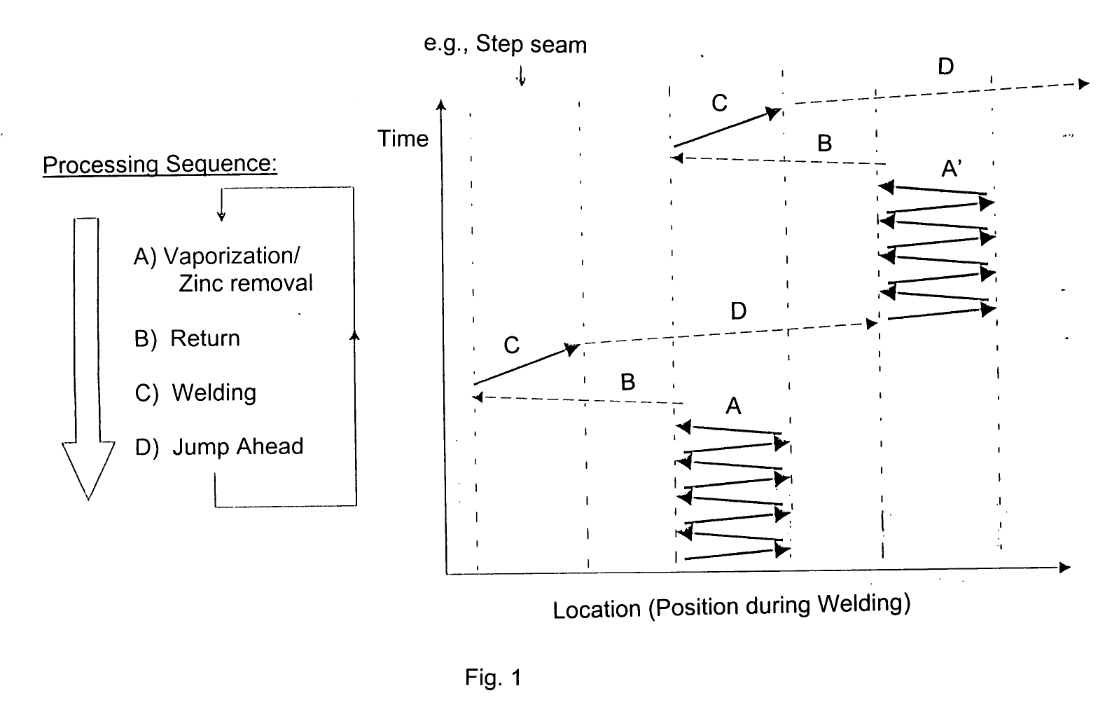

According to a first illustrative embodiment two coated sheets (as conventionally employed in automobile construction) are positioned over each other without a gap, a scanner device is moved evenly thereover and directs a laser beam sequentially to multiple work segments. The scanner device is comprised of a two-dimensional pivotable computer-controlled mirror system. The scanner device is located with approximately 320 mm separation to the upper surface of the first sheet. The focus of the laser beam is approximately 20 mm above the surface of the first sheet. The defocused illumination surface is approximately 200% larger than the focus surface would have been. According to FIG. 1 the defocused laser beam is rapidly guided (rate of advancement: approximately 10 m/s) multiple times (advanced four times and returned four times, see FIG. 1) over the work segment of approximately 5 mm length. By the defocusing of the laser beam there occurs a planar and more even warming of the work surface, which as a result of the multiple passes is sufficient to warm the laser-facing sheet to the extent that the coating of both sheets evaporates and distributes itself between the sheets, wherein the vapor condenses in cooler areas. After the de-coating of this first processing segment, the process is repeated along a second work segment, the beginning of which is located approximately 5 mm from the end of the first processing segment in the direction of advancement of the laser. Thereafter there occurs laser welding along the first uncoated working line with reduced speed of advance. This joins a third de-coating line as well as a second weld seam. These alternating process steps are carried out so that a dashed weld seam forms in the manner of a step seam.

In a second illustrative embodiment the process proceeds analogous to the first illustrated embodiment; however, the degree of defocusing is reduced. The focus of the laser beam is only approximately 5 mm above the surface of the first sheet. Thereby the processing time is shorter (the illumination surface is approximately 50% larger than in the case of a focus surface area) and the intensity in the case of the same laser intensity is higher than in the first embodiment. The laser beam is again guided over the work segment, however with four times the speed of advance in order to avoid a premature melting of the sheet metal. The advance movement has a transverse movement component superimposed upon the main direction of advance (so-called beam spinning). The beam describes a spiral or sinus like movement about the processing line. Therewith, despite higher laser intensity per surface area unit, nevertheless an even processing of a broad working surface can be ensured. At the same time, due to the stronger focusing, by appropriate selection of the transverse movement it becomes possible also to produce a precise weld seam of complicated geometry.

The inventive process has proved itself in the illustrative embodiments of the above-described examples as particularly suited for laser welding of coated sheets in the automobile industry.

In particular therewith substantial advantages can be achieved with respect to the construction cost and complexity of the apparatus. However the processing time is also reduced and the corrosion protection is improved by the absence of the gap in which moisture could otherwise collect.

The invention is not limited to the above-described illustrated examples, but rather can be broadly applied.

Thus it is conceivable for example that the scanner device, in place of a mirror system, is constructed of an acoustic-optical modulator. Further, it is possible, instead of guiding the laser scanner over the construction component surface, to move the component part under a spatially fixed scanner. In certain cases, scanner and component part can carry out movements coordinated to each other.

Also, the distance of the scanner device from the sheet metal and the degree of defocusing are not particularly limited and could be adapted as required, for example according to the laser power or also the material of the sheet and/or coating. It can be advantageous to vary the laser output during irradiation in suitable manner.

Finally, the process is not limited to the welding of coated metal sheets, but rather is applicable to the welding of plastic sheets.

1-6. (canceled)

7. A process for laser welding two coated plates, which are positioned closely contacting each other, wherein:
during a first process step the plate facing the laser beam is warmed with the laser beam in such a manner
that the coating of both plates on their sides facing each other is evaporated, leaving a de-coated area, and
that no plate is completely melted through, and
during a second process step the two plates are welded along the de-coated area,
wherein both process steps are carried out by the same laser beam with substantially the same output and focusing, however, the second process step is carried out with reduced speed of advance of the laser over the surface.

8. The process according to claim 7, wherein the laser beam is guided on the surface via a scanner device.

9. The process according to claim 7, wherein the laser beam is focused in such a manner that its focus is from 0 and 50 mm from the surface of the laser beam facing plate.

10. The process according to claim 7, wherein the laser beam is focused in such a manner that its focus is approximately 20 mm from the surface of the laser beam facing plate.

11. The process according to claim 7, wherein the laser beam is moved along a main direction of advance to form a seam, and wherein said laser beam is guided during the second process step in such a manner that a transverse movement component is superimposed upon the main direction of advance (so-called beam spinning).

12. The process according to claim 7, wherein the laser beam is moved along a main direction of advance to form a seam, and wherein said laser beam is guided during the second process step in such a manner that a transverse movement component is superimposed upon the main direction of advance to produce beam spinning.

13. The process according to claim 7, wherein the first and second process steps occur alternatingly in the form of a step seam.

14. The process according to claim 7, wherein no plate melts during the first process step.

15. The process according to claim 7, wherein said plates are metal plates.

16. The process according to claim 7, wherein said plates are plastic plates.
